(19) United States
(12) Patent Application Publication
(10) Pub. No.: US 2009/0170529 A1
(43) Pub. Date: Jul. 2, 2009

(54) EMERGENCY EXIT ROUTING USING WIRELESS DEVICES DURING EMERGENCY SITUATIONS

(75) Inventor: John Richard KANE, Fox River Grove, IL (US)

Correspondence Address: FLEIT, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/965,204

(22) Filed: Dec. 27, 2007

(51) Int. Cl. H04Q 7/20

(52) U.S. Cl. 455/456.3

(57) ABSTRACT

A method and wireless device direct a user to safety during an emergency situation. A wireless device (102) receives an emergency signal (121) from an emergency alerting device (120). The wireless device (102) extracts directional information from the emergency signal (121). The wireless device (102) directs a user to an exit associated with the emergency alerting device (120) based on the directional information extracted from the emergency signal (121).

### CROSS-REFERENCE TO RELATED APPLICATIONS

This application is related to co-pending U.S. patent application Ser. No. ______, filed on Dec. ______, 2007, Attorney Docket No. CML04445AS, and entitled “PROMPTING AND DIRECTING USERS TO SAFETY DURING EMERGENCY SITUATIONS”; the entire disclosure of the above-identified application being hereby incorporated by reference.

### FIELD OF THE INVENTION

The present invention generally relates to the field of emergency alerts, and more particularly relates to providing wireless devices with emergency exit information during an emergency situation.

### BACKGROUND OF THE INVENTION

Emergency alert systems are used to communicate vital information to the public during emergency situations. This information is generally conveyed to the public via televisions or public addressing systems. However, recent advances in technology have allowed wireless communications systems such as cellular systems to be used as an alerting system. For example, a wireless communication network can operate in an emergency mode. A mobile device can enter into an emergency mode and perform various functions such as repeating signals to proximate mobiles, responding with indications of user presence, transmitting an emergency beacon, and sending position information to a network.

Another example is that messages from the national Emergency Alert System (“EAS”) are routed to mobile stations via a wireless network. This system receives a message that is to be broadcasted to a geographic area and transmits a notice to one or more mobile stations in the geographic area. These notices inform the mobile stations to tune to a broadcast channel. The message is then broadcasted on that channel to the mobile stations until a termination notice is received from the message source.

One problem with the above systems and similar systems is that the individual wireless devices are not targeted. Stated differently, individualized information is not transmitted to a wireless device during emergency situations. For example, wireless devices are not provided with information such as emergency exit directions when a user is within a structure during times of an emergency.

Therefore a need exists to overcome the problems with the prior art as discussed above.

### SUMMARY OF THE INVENTION

Briefly, in accordance with the present invention, disclosed is a method for directing a user to safety during an emergency situation using a wireless device. The method includes determining, by an emergency alerting device, that an emergency condition has occurred. An emergency alerting device identifies at least one wireless device within a given area. The emergency alerting device transmits an emergency signal to the each of the at least one wireless device. Each of the at least one wireless device directs each user associated with each of the at least one wireless device to an exit associated with the emergency alerting device based on the emergency signal.

In another embodiment, a method for directing a user to safety during an emergency situation is disclosed. A wireless device receives an emergency signal from an emergency alerting device. The wireless device extracts directional information from the emergency signal. The wireless device directs a user to an exit associated with the emergency alerting device based on the directional information extracted from the emergency signal.

In yet another embodiment, a wireless device for directing a user to safety during an emergency situation is disclosed. The wireless device includes a memory and a processor that is communicatively coupled to the memory. A user interface is communicatively coupled to the memory and the processor. An emergency alert manager is communicatively coupled to the memory, processor, and user interface. The emergency alert manager is adapted to receive an emergency signal from an emergency alerting device. Directional information is extracted from the emergency signal. A user is directed via the user interface to an exit associated with the emergency alerting device based on the directional information extracted from the emergency signal.

An advantage of the foregoing embodiments is that wireless devices are provided with emergency exit routing information during times of an emergency. Emergency alerting devices can be situated throughout a structure such as an office building, shopping center, hotel, and any other public building. When an emergency alerting device detects that an emergency situation exists, the alerting devices generate an emergency beacon that wireless devices can follow to safety. Another advantage is that the emergency beacons can carry directional information that direct a user of a wireless device to safety.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general operational environment, according to one embodiment of the present invention;

FIGS. 2-3 are examples of a user interface for displaying emergency exit information to a user according to one embodiment of the present invention;

FIG. 4 is an operational flow diagram illustrating a process of directing a user of a user to an exit during an emergency situation via the user's wireless device according to one embodiment of the present invention;

FIG. 5 is an operational flow diagram illustrating a process of prompting a user for locating an exit during an emergency situation according to one embodiment of the present invention;

FIG. 6 is a block diagram illustrating a detailed view of a wireless device according to one embodiment of the present invention; and

FIG. 7 is a block diagram illustrating a detailed view of an information processing system according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term “wireless device” is intended to broadly cover many different types of devices that can wirelessly receive signals, and optionally can wirelessly transmit signals, and may also operate in a wireless communication system. For example, and not for any limitation, a wireless communication device can include any one or a combination of the following: a two-way radio, a cellular telephone, a mobile phone, a smartphone, a two-way pager, a wireless messaging device, a laptop/computer, a personal digital assistant, and other similar devices.

General Operating Environment

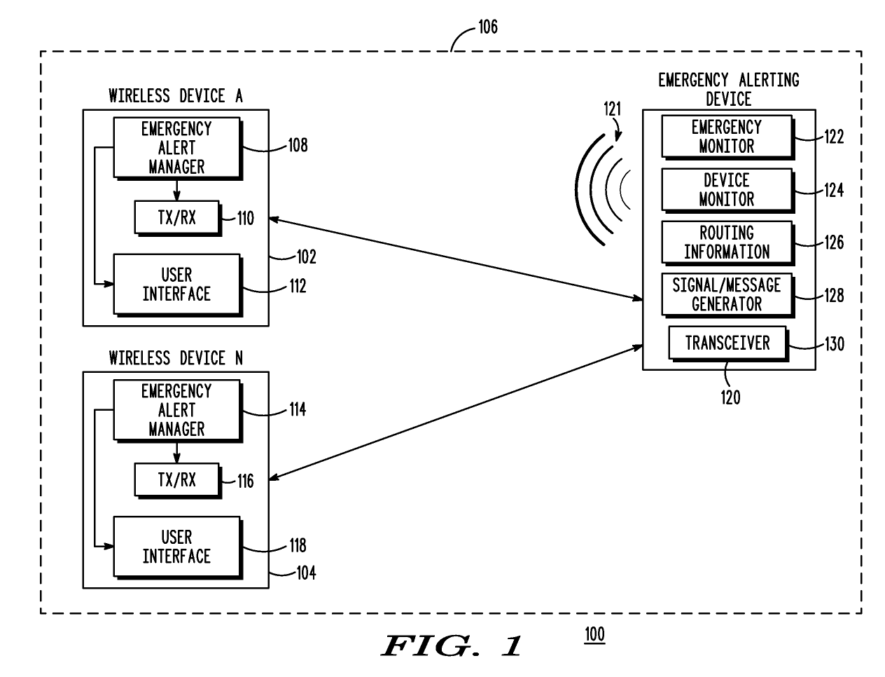

According to one embodiment of the present invention, as shown in FIG. 1, a general operating environment 100 for implementing one or more embodiments of the present invention is illustrated. In particular, FIG. 1 shows a plurality of wireless devices 102, 104 within a structure 106 such as an office building, shopping center, hospital, hotel, stadium, cruise ship, hurricane shelter, tornado shelter, or any other type of structure. It should be noted that although FIG. 1 shows a structure 106, the various embodiments of the present invention are also applicable to open environments as well. For example, the present invention is also applicable to environments such as (but not limited to) outdoor shopping centers, amusement parks, city parks, or any other open environment. Each wireless device 102, 104 includes an emergency alert manager 108, 114, a transceiver 110, 116, and a user interface 112, 118. Each of these components is discussed in greater detail below.

The environment 100 also includes one or more emergency alerting devices (“EAD”) 120 that can be communicatively coupled to the wireless devices 102, 104 during emergency situations. The example of FIG. 1 shows the EAD 120 being located within the structure 106, however this is not required. The EAD 120 can be a stand-alone unit or integrated within one or more emergency systems/components of the structure 106. For example, the EAD 120 can be mechanically coupled to an emergency exit, smoke detector, heat detector, air quality detector, emergency lighting system, or any other emergency system/component within the structure 108.

The EAD 120 includes an emergency monitor 122, a device monitor 124, routing information 126, a signal/message generator 128, and a transceiver 130. Each of these components is discussed in greater detail below. Although only one EAD 120 is shown within FIG. 1, it should be noted that multiple EADs 120 can be situated throughout the structure 106. For example, each emergency exit within a building or each floor of a building can include one or more EADs 120.

Routing Emergency Exit Information to Wireless Devices

During times of an emergency such as a fire, hurricane, tornado, blackout, national emergency, or any other type of emergency or critical situation, the EAD 120 provides an emergency beacon 121 to a wireless device 102, 104. This emergency beacon 121 can include critical information such as emergency exit/evacuation routing information to the wireless devices 102, 104. The emergency monitor 122 monitors for and detects when an emergency situation is occurring. For example, the EAD 120 can be communicatively coupled to the national EAS system and receives a notification when an emergency such as (but not limited to) a tornado, hurricane, or national emergency is occurring or is going to occur.

Alternatively, the EAD 120 can be communicatively coupled to a local emergency system instead of or in addition to the national EAS. For example, an office building can include a fire alarm system, biological warning system, tornado or hurricane warning system, or other similar warning systems. The EAD 120, in this embodiment, can receive a signal form one of these local systems. A signal 121, for example, can be generated when a fire is detected; when an emergency door is opened, when emergency lighting is activated; when a fire alarm is activated; or by other similar means.

Once the emergency monitor 122 receives a signal indicating an emergency situation, the device monitor 124 identifies the wireless devices 102, 104 within the vicinity of the EAD 122 via the transceiver 130. For example, the device monitor 124, via the transceiver 130, detects wireless signals emitted from the wireless devices 012, 104 from their transceivers 110, 116 and stores the unique identifier of the wireless device in memory. The transceiver 130, 110 of the EAD 120 and a wireless device 102 can utilize various technologies such as Bluetooth, WiFi, Zigbee, or any other short range radio technology. It should be noted that the present invention is not limited to short range technologies. The EAD systems 120 can be situated among each other so that as a wireless device 102, 104 becomes out of range of one EAD another EAD detects the device.

For example, consider a first EAD (east EAD) that is situated at a first emergency exit or stairwell located at an east wing of a floor. As the wireless device 102 moves further west away from the east emergency exit or stairwell the wireless device 102 becomes out of range of the east EAD. However, another EAD (west EAD) situated at a second emergency exit or stairwell located at the west wing of the floor detects and communicates with the wireless device 102

The EAD 120 within range of a wireless device 102 determines a routing strategy for the wireless device 102 using its internal routing information 126. The internal routing information 126 comprises a plurality of routing plans that can be used by the EAD 120 for directing a wireless device 102 to an emergency exit. For example, the device monitor 124 can determine a current location of the wireless device 102 or whether the device 102 is moving closer to or away from the EAD 120 using a variety of positioning methods. For example, the EAD 120 can utilize GPS technology or monitor signal strength (where a decreasing signal indicates the device is moving away from the EAD 120 and an increasing signal indicates the device is moving towards the EAD 120). The present invention is not limited to a particular method for determining the current position or direction of a wireless device.

Once the routing plan is determined (such as head east; turn left in 20 feet; continue your current direction) the EAD 120 can output this information to the wireless device 102. The message can include routing information such as head east; turn left in 20 feet; continue your current direction; information regarding the emergency; current location information with respect to the nearest emergency exit; emergency safety tips; or other similar information. The message type can be (but is not limited to) a text message, a multimedia message, an email, an automated message, or any other similar messaging types. The messages include text, pictures, voice prompts, and other visual and audio indicators.

The EAD 120 can utilize its own communication system or any other network communicatively coupled to EAD 120 for sending out the message. For example, the EAD 120 can out the routing message to a wireless device 120 using the emergency signal/beacon 121 generated by the signal/message generator 128. In other words, the EAD 120 and the wireless device 102 can communicate directly with each other utilizing their internal technologies such as Bluetooth, WiFi, Zigbee, or any other RF technology. Alternatively, the EAD 120 can be communicatively coupled to various access networks such as a circuit switched or packet data network; a local area network; or a public switched telephone network and utilize these networks to send the routing message or even the emergency signal/beacon.

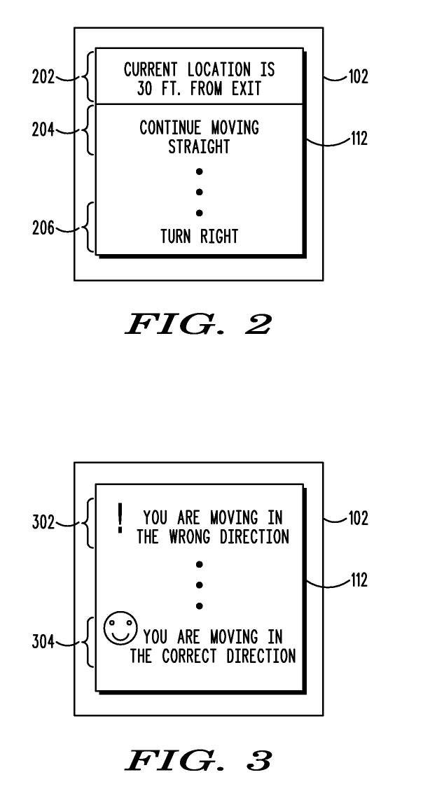

The wireless device 102 detects the emergency signal/beacon 121 and the based on the signal 121 the emergency alert manager 108 within the device 102 determines that an emergency condition exists. If the signal 121 includes routing information or is accompanied by routing information the emergency alert manager 108 displays the routing information to the user via the user interface 112. The user is then able to follow the routing directions to the nearest or safest exit. For example, FIG. 2 shows one example of the user interface 112 of the wireless device 102 displaying routing information received from the EAD 120. In particular, FIG. 2 shows information 202 such as the current location with respect to the nearest or safest exit. FIG. 2 also shows that the information can change as the user moves. For example, a first routing prompt 204 tells the user to keep moving straight or in the current direction. As the user moves, a second prompt 206 tells the user to turn right.

It should be noted that the device monitor 124, routing information 126, and message generator 128 within the EAD 120 are optional. For example, the EAD 120, in one embodiment, only generates the emergency signal 121 that is detected by the wireless device 102, as discussed above. In this embodiment, the wireless device 102 periodically checks if an emergency signal 121 from an EAD 120 is detected. The EAD 120 generates the emergency signal 121 when it detects an emergency condition as discussed above. The emergency signal 121, in one embodiment, includes a direction indicator that the wireless device 102 saves for a later comparison as the device 102 moves about its location.

As the user moves, the emergency alert manager 108 acquires another direction indictor from the emergency signal 121. The emergency alert manager 108 compares this new direction indictor the original direction indicator to determine if the user has moved away from or closer to the EAD 120. If the user has moved away from the EAD 120, the emergency alert manager 108 notifies the user that he/she is traveling in the wrong direction. If the user has moved closer to the EAD 120, the emergency alert manager 108 notifies the user that he/she is traveling in the correct direction.

For example, FIG. 3 shows the user interface 112 of the wireless device 102 displaying routing notifications to the user as the user moves about a location. In particular, FIG. 3 shows a first prompt 302 that notifies the user that he/she is moving in the wrong direction with respect to the nearest or safest exit. FIG. 3 also shows a second prompt 304 that notifies the user when he/she is moving in the correct direction with respect to the nearest or safest exit. The user can use these prompts to locate the direction with respect to the nearest or safest exit.

As can be seen, the various embodiments of the present invention are advantageous because a user is able to locate an emergency exit or follow an evacuation plan using his/her wireless device during times of an emergency. The relevant routing information can be displayed to a use via his/her wireless device.

Process for Directing a User of a Wireless Device to an Exit During an Emergency Situation

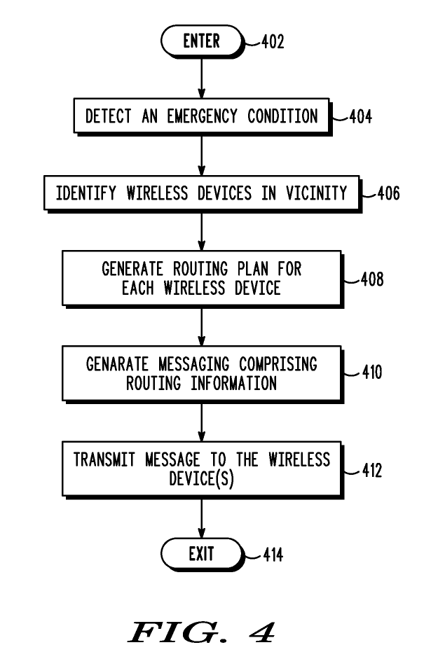

FIG. 4 is an operational flow diagram illustrating a process of directing a user of a user to an exit during an emergency situation via the user's wireless device. The operational flow diagram of FIG. 4 begins at step 402 and flows directly to step 404. The EAD 120, at step 404, detects an emergency condition as discussed above. For example, the EAD 120 can receive a signal from the national EAS system, a local emergency monitoring system, or an emergency notification device such as (but not limited to) a siren, emergency lights.

The EAD 120, at step 406, identifies any wireless devices 102, 104 in its vicinity. A routing plan, at step 408, for each of the identified wireless devices 102, 104 is generated. The EAD 120, at step 410, then generates an emergency signal 121 that includes the routing information or can generate an additional message to accompany the emergency signal 121. The routing information, at step 412, is then transmitted to the wireless device(s) 102, 104. The control flow then exits at step 414. It should be noted that steps 406-412 are optional. For example, the EAD 120 can generate an emergency signal 121 once an emergency condition is detected. This emergency signal 121 is then used by the wireless device 102, 104 to locate the nearest or safest exit as discussed above.

Process for Prompting a User of a Wireless Device for Locating an Exit During an Emergency Situation

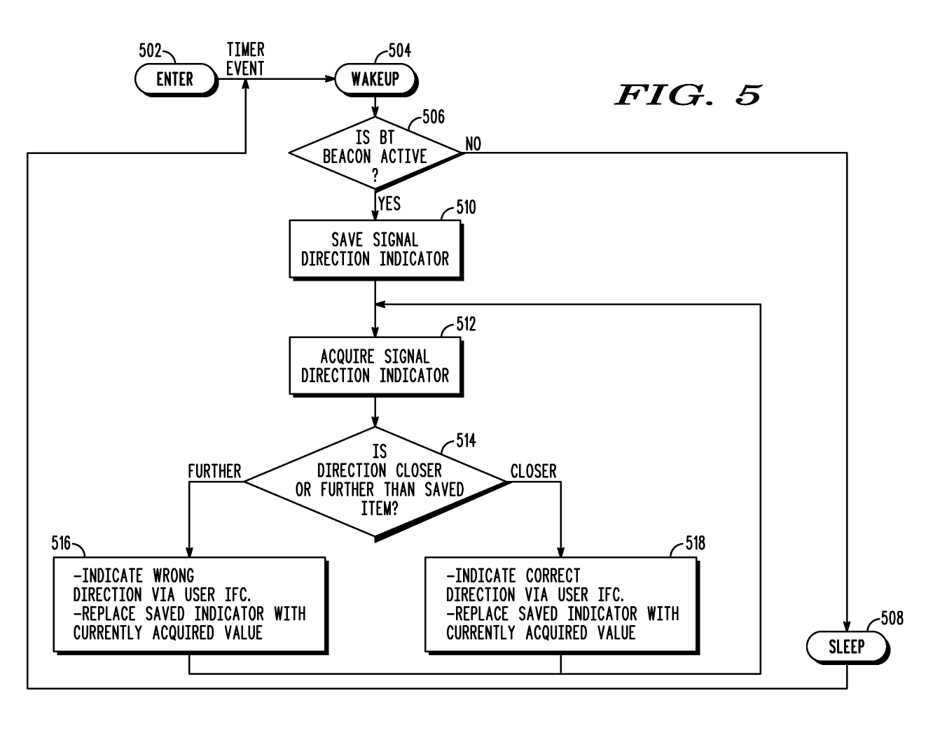

FIG. 5 is an operational flow diagram illustrating a process of prompting a user for locating an exit during an emergency situation. The operational flow diagram of FIG. 5 begins at step 502 and flows directly to step 504. The wireless device 102, at step 504, determines that a timer has expired for identifying any emergency signals 121 and the wireless device 102 “wakes up”. The wireless device 102, at step 506, determines if any emergency signals 121 are active. If the result of this determination is negative, the wireless device 102, at step 508, goes back to “sleep”. The control flow returns to step 504. If the result of this determination is positive, the wireless device 102, at step 510, analyzes the signal 121 signal and saves a direction indicator within the signal 121. The wireless device 102 can optionally extract information within the beacon and display it to the user via the user interface 112. This information can be routing information as discussed above.

The user begins to move about the location and the wireless device 102, at step 512, acquires another direction indicator form the emergency signal 121. The wireless device 102, at step 514, compares the original direction indicator to the newly acquired direction indicator to determine if the newer indicator is closer or farther away from the original indicator. If the wireless device 102, determines that it is moving further away from the EAD 120 generating the signal 121, the wireless device 102, at step 516, notifies the user via the user interface 112 that he/she is moving in the wrong direction. The original indicator is replaced with the newly acquired indicator. The control flows back to step 512. If the wireless device 102, determines that the wireless device is moving closer to the EAD 120 generating the beacon, the wireless device 102, at step 518 notifies the user via the user interface 112 that he/she is moving in the correct direction. The original indicator is replaced with the newly acquired indicator. The control flow then returns to step 512.

Wireless Device

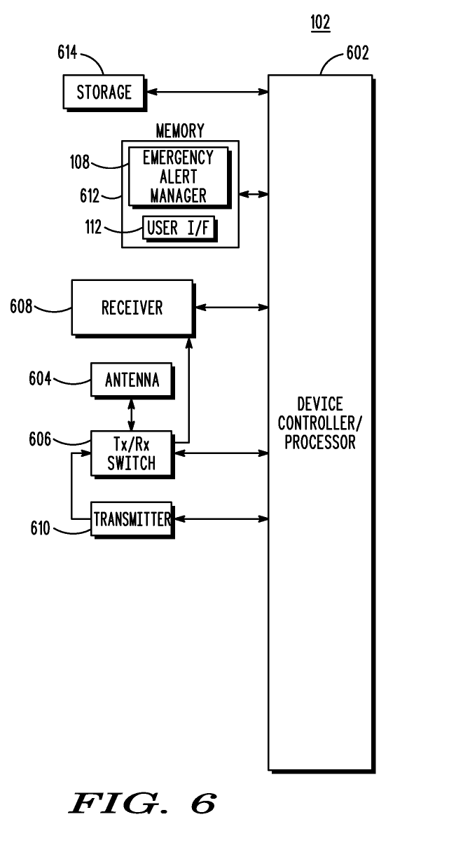

FIG. 6 is a block diagram illustrating a detailed view of the wireless device 102 according to one embodiment of the present invention. It is assumed that the reader is familiar with wireless communication devices. To simplify the present description, only that portion of a wireless communication device that is relevant to the present invention is discussed. The wireless device 102 operates under the control of a device controller/processor 602, that controls the sending and receiving of wireless communication signals. In receive mode, the device controller 602 electrically couples an antenna 604 through a transmit/receive switch 606 to a receiver 608. The receiver 608 decodes the received signals and provides those decoded signals to the device controller 602.

In transmit mode, the device controller 602 electrically couples the antenna 604, through the transmit/receive switch 606, to a transmitter 610. The wireless device 102 can also include an additional transceiver 110 as discussed above. However, the receiver 608/transmitter 610 can also provide the functionality of the transceiver 110 discussed above. The wireless device 102 also includes volatile memory 112 and non-volatile storage memory 614. Either of these memories 112, 114 can include the emergency alert manager 108 and the software components of user interface 112. Each of these components has been discussed above in greater detail.

Information Processing System

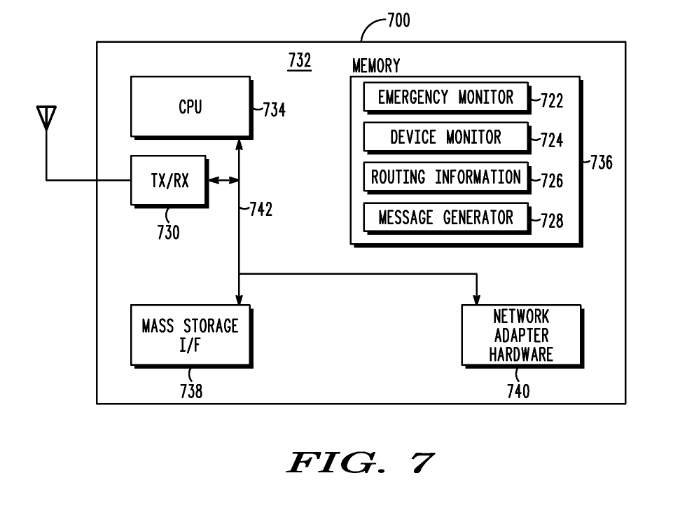

FIG. 7 is a block diagram illustrating a detailed view of an information processing system 700 such as the EAD 120 system 116 discussed above. The information processing system 700 includes a computer 732. The computer 732 has a processor 734 that is connected to a main memory 736, a transceiver 730, a mass storage interface 738, and network adapter hardware 740. A system bus 742 interconnects these system components. The mass storage interface 738 is used to connect mass storage devices, such as a data storage device to the information processing system 700.

The main memory 736, in one embodiment, includes an emergency monitor 722, a device monitor 724, routing information 726, and a signal/message generator 728, which have discussed above in greater detail. The network adapter hardware 740 is used to provide an interface to a network (not shown). Various embodiments of the present invention can be adapted to work with any data communications connections including present day analog and/or digital techniques or via a future networking mechanism.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for directing a user to safety during an emergency situation using a wireless device, the method comprising:
determining, by an emergency alerting device, that an emergency condition has occurred;
identifying, by an emergency alerting device, at least one wireless device within a given area;
transmitting, by an emergency alerting device, an emergency signal to the each of the at least one wireless device; and
directing, by each of the at least one wireless device, each user associated with each of the at least one wireless device to an exit associated with the emergency alerting device based on the emergency signal.

2. The method of claim 1, wherein determining that an emergency condition has occurred, further comprises:
receiving an emergency signal from at least one of a national government, state government, and local government Emergency Alert System.

3. The method of claim 1, wherein determining that an emergency condition has occurred, further comprises:
receiving an emergency signal from at least one emergency notification system component, wherein the at least one emergency notification system component includes at least one of:
a fire alarm;
a Public Addressing system; and
an emergency lighting system.

4. The method of claim 1, wherein transmitting an emergency signal to the each of the at least one wireless device, further comprises:
transmitting the emergency signal using a short range radio frequency communication component.

5. The method of claim 4, wherein the short range radio frequency communication component comprises one of:
a Bluetooth component;
a WiFi component; and
a ZigBee component.

6. The method of claim 1, wherein transmitting an emergency signal to the each of the at least one wireless device further comprises:
embedding directional information in the emergency signal, wherein the directional information directs the user to the exit.

7. The method of claim 1, wherein the directing by each of the at least one wireless device further comprises.
determining, based at least in part on information within the emergency signal that the user is moving away from the exit; and
directing the user to move in a different direction.

8. The method of claim 1, wherein the directing by each of the at least one wireless device further comprises.
determining, based at least in part on information within the emergency signal that the user is moving towards the exit; and
directing the user to continue moving in a current direction.

9. A method with a wireless device for directing a user to safety during an emergency situation, the method comprising:
receiving, by a wireless device, an emergency signal from an emergency alerting device;
extracting, by the wireless device, directional information from the emergency signal; and
directing, by the wireless device, a user to an exit associated with the emergency alerting device based on the directional information extracted from the emergency signal.

10. The method of claim 9, wherein receiving an emergency signal from an emergency alerting device, further comprises:
determining, by the wireless device, that a given interval has passed;
monitoring, by the wireless device, for the emergency signal in response to the given interval having passed; and
detecting, by the wireless device, the emergency signal, in response to the monitoring.

11. The method of claim 9, wherein the emergency signal is received on a short range radio frequency communication link.

12. The method of claim 11, wherein the short range radio frequency communication link comprises one of:
a Bluetooth communication link;
a WiFi component; and
a ZigBee communication link.

13. The method of claim 9, wherein directing a user to an exit, further comprises:
determining a current location of the wireless device;
comparing the current location of the wireless device with the directional information; and
notifying, in response to the comparing, the user to one of change a direction of movement and continue a current direction of movement.

14. The method of claim 13, where notifying the user to one of change a direction of movement and continue a current direction of movement, further comprises notifying a user by at least one of:
a display on the wireless device;
an audile alert;
a visual alert; and
a tactile alert.

15. A wireless device for directing a user to safety during an emergency situation, the wireless device comprising:
a memory;
a processor;
a user interface communicatively coupled to the memory and the processor; and
an emergency alert manager communicatively coupled to the memory, the processor, and the user interface, wherein the emergency alert manager is adapted to:
receive an emergency signal from an emergency alerting device;
extracting directional information from the emergency signal; and
directing, via the user interface, a user to an exit associated with the emergency alerting device based on the directional information extracted from the emergency signal.

16. The wireless device of claim 15, wherein the emergency alert manager is further adapted to receive an emergency signal from an emergency alerting device, by:
determining that a given interval has passed;
monitoring for the emergency signal in response to the given interval having passed; and
detecting the emergency signal, in response to the monitoring.

17. The wireless device of claim 15, wherein the emergency signal is received on a short range radio frequency communication link.

18. The wireless device of claim 17, wherein the short range radio frequency communication link comprises one of:
a Bluetooth communication link;
a WiFi communications link; and
a ZigBee communication link.

19. The wireless device of claim 15, wherein the emergency alert manager is further adapted to direct a user to an exit by:
determining a current location of the wireless device;
comparing the current location of the wireless device with the directional information; and
notifying, in response to the comparing, the user to one of change a direction of movement and continue a current direction of movement.

20. The wireless device of claim 19, wherein the emergency alert manager is further adapted to notify the user to one of change a direction of movement and continue a current direction of movement by notifying a user using at least one of:
a display on the wireless device;
an audile alert;
a visual alert; and
a tactile alert.
